(19) United States
(12) Patent Application Publication
(10) Pub. No.: US 2022/0207339 A1
(43) Pub. Date: Jun. 30, 2022

(54) ASSIGNMENT DEVICE, METHOD, AND PROGRAM

(71) Applicant: NEC Corporation, Minato-ku, Tokyo (JP)

(72) Inventors: Takashi TAKENAKA, Tokyo (JP); Fumiyo TAKANO, Tokyo (JP); Seiya SHIBATA, Tokyo (JP); Hiroaki INOUE, Tokyo (JP)

(73) Assignee: NEC Corporation, Minato-ku, Tokyo (JP)

(21) Appl. No.: 17/607,473

(22) PCT Filed: May 8, 2019
(86) PCT No.: PCT/JP2019/018430

§ 371 Date: Oct. 29, 2021

(51) Int. Cl. G06N 3/063

(52) U.S. Cl. CPC G06N 3/063

(57) ABSTRACT

The determining unit 72 divides channels in the 0th layer and channels in the first layer into groups whose number is equal to the number of chips that are included in an operation device executing an operation of the neural network using a learning result of the weight for each edge, respectively. The determining unit 72 determines association of the groups of the channels in the 0th layer and the groups of the channels in the first layer and the chips included in the operation device, and edges to be removed, and removes the edges to be removed. The weight assignment unit 73 stores the weights of the edges in the weight storage unit in the chip corresponding to the edge.

### TECHNICAL FIELD

The present invention relates to an assignment device that assigns weights in a neural network to chips of an operation device that executes operations of a neural network by a plurality of chips.

### BACKGROUND ART

Patent literatures 1 and 2 describe circuits, etc. that perform parallel processing.

In addition, non-patent literature 1 describes a device that processes one frame and the next frame in a video with different circuits.

Non-patent literature 2 describes a device that performs the processing of the first through nth layer of a neural network, and the processing of the (n+1)th and subsequent layers with different circuits.

In addition, grouped convolution is described in non-patent literature 3.

Non-Patent literature 4 describes a technique to set a weight in a neural network to zero.

Non-patent literature 5 describes a technique to reduce a weight in a neural network.

### CITATION LIST

### Patent Literatures

PTL 1: Japanese Patent Application Laid-Open No. 2018-67154
PTL 2: Japanese Patent Application Laid-Open No. 2018-55570

### Non Patent Literatures

NPL 1: Weishan Zhang et al., “Distributed Embedded Deep Learning based Real-Time Video Processing”, 2016 IEEE International Conference on Systems, Man, and Cybernetics, SMC 2016, October, 2016
NPL 2: Jong Hwan Ko, Taesik Na, Mohammad Faisal Amir, Saibal Mukhopadhyay, “Edge-Host Partitioning of Deep Neural Networks with Feature Space Encoding for Resource-Constrained Internet-of-Things Platforms”, [online], [retrieved Oct. 2, 2018], Internet <URL: https://arxiv.org/pdf/1802.03835.pdf>
NPL 3: “Technical Memorandum Collection,” [online], Dec. 29, 2017, [retrieved Oct. 2, 2018], Internet <URL: https://www.robotech-note.com/entry/2017/12/29/084349>
NPL 4: Song Han et al., “Learning Both Weights and Connections for Efficient Neural Networks”, [online], [retrieved 5 Feb. 2019], Internet<URL: https://arxiv.org/pdf/1506.02626.pdf>
NPL 5: Guodong Zhang et al., “THREE MECHANISMS OF WEIGHT DECAY REGULARIZATION”, [online], [retrieved 11 Apr. 2019], Internet <URL: https://arxiv.org/pdf/1810.12281.pdf>

### SUMMARY OF INVENTION

### Technical Problem

In recent years, operations of a neural network have become increasingly large-scale. This makes it difficult to perform high-speed operations when operations of a neural network are performed on a single chip.

On the other hand, it is possible to perform neural network operations on multiple chips. In such a case, if the amount of data communication between chips increases, it becomes difficult to perform high-speed operations.

Therefore, it is an object of the present invention to provide an assignment device, an assignment method, and an assignment program that can define edges between neighboring layers so that the amount of data communication between chips can be suppressed, and also can assign weights to chips of an operation device that performs neural network operations by a plurality of chips.

### Solution to Problem

An assignment device according to the present invention comprises: a learning unit which learns a weight for each edge connecting a channel in a first layer that is a layer in a neural network, and a channel in a 0th layer which is a previous layer to the first layer, a determination unit which divides channels in the 0th layer and channels in the first layer into groups whose number is equal to the number of chips that are included in an operation device executing an operation of the neural network using a learning result of the weight for each edge, respectively, determines association of the groups of the channels in the 0th layer and the groups of the channels in the first layer and the chips included in the operation device, and edges to be removed, and removes the edges to be removed, and a weight assignment unit which stores the weights for the edges each connecting the channel in the 0th layer and the channel in the first layer to a weight storage unit in the chip corresponding to the edge.

An assignment method according to the present invention is executed by a computer, and comprises: executing a learning process for learning a weight for each edge connecting a channel in a first layer that is a layer in a neural network, and a channel in a 0th layer which is a previous layer to the first layer, executing a determination process for dividing channels in the 0th layer and channels in the first layer into groups whose number is equal to the number of chips that are included in an operation device executing an operation of the neural network using a learning result of the weight for each edge, respectively, determining association of the groups of the channels in the 0th layer and the groups of the channels in the first layer and the chips included in the operation device, and edges to be removed, and removing the edges to be removed, and executing a weight assignment process for storing the weights for the edges each connecting the channel in the 0th layer and the channel in the first layer to a weight storage unit in the chip corresponding to the edge.

An assignment program according to the present invention causes a computer to execute: a learning process for learning a weight for each edge connecting a channel in a first layer that is a layer in a neural network, and a channel in a 0th layer which is a previous layer to the first layer, a determination process for dividing channels in the 0th layer and channels in the first layer into groups whose number is equal to the number of chips that are included in an operation device executing an operation of the neural network using a learning result of the weight for each edge, respectively, determining association of the groups of the channels in the 0th layer and the groups of the channels in the first layer and the chips included in the operation device, and edges to be removed, and removing the edges to be removed, and a weight assignment process for storing the weights for the edges each connecting the channel in the 0th layer and the channel in the first layer to a weight storage unit in the chip corresponding to the edge.

### Advantageous Effects of Invention

According to the invention, the edges between neighboring layers can be defined so that the amount of data communication between chips can be suppressed, and weights can be assigned to the chips of the operation device that performs the neural network operations by a plurality of chips.

### BRIEF DESCRIPTION OF DRAWINGS

FIG. 1 It depicts a schematic diagram showing an example of multiple channels in L0 and L1 layers.

FIG. 2 It depicts a schematic diagram showing values used to calculate each feature value group in the L1 layer.

FIG. 3 It depicts a block diagram showing an example of an operation device that performs neural network operations with multiple chips.

FIG. 4 It depicts a schematic diagram showing an example where the channels CH1 and CH2 of the L0 layer and the channels CH1 to CH3 of the L1 layer shown in FIG. 1 are divided into groups with the same number of chips.

FIG. 5 It depicts a schematic diagram showing feature value groups of the L0 layer that are transmitted and received between chips 10, 20 for the calculation of the feature value groups of channels of the L1 layer, in the example shown in FIG. 4.

FIG. 6 It depicts a block diagram showing an exemplary configuration of the assignment device of the first example embodiment of the present invention.

FIG. 7 It depicts a flowchart showing an example of a process of the assignment device in the first example embodiment.

FIG. 8 It depicts a flowchart showing an example of a process of the assignment device in the first example embodiment.

FIG. 9 It depicts a schematic diagram showing an example of the result of step S6.

FIG. 10 It depicts a schematic diagram showing values used to calculate each feature value group in the L1 layer, in the example shown in FIG. 9.

FIG. 11 It depicts a block diagram showing an exemplary configuration of the assignment device of the second example embodiment of the present invention.

FIG. 12 It depicts a schematic diagram showing an example of grouping and association that satisfies the condition that the channels in the L0 layer and the channels in the L1 layer that were connected by the removed edges belong to non-corresponding groups of channels in the L0 layer and in the L1 layer.

FIG. 13 It depicts a flowchart showing an example of a process of the assignment device 40 in the second example embodiment.

FIG. 14 It depicts a schematic diagram showing values used to calculate each feature value group in the L1 layer, in the example shown in FIG. 12.

FIG. 15 It depicts a schematic block diagram showing an exemplary configuration of a computer according to the assignment device of each example embodiment.

FIG. 16 It depicts a block diagram showing an overview of the assignment device of the present invention.

### DESCRIPTION OF EMBODIMENTS

Before explaining the example embodiment of the present invention, an operation of a neural network is explained. In the operation of a neural network, when calculating values in a layer, the values calculated in the previous layer are used. Such calculation of values is performed sequentially for each layer. In the following explanation, the layer for which values are to be calculated and the previous layer are focused on. The layer where the values are to be calculated is called the L1 layer, and the layer before the L1 layer is called the L0 layer, where the values have already been calculated.

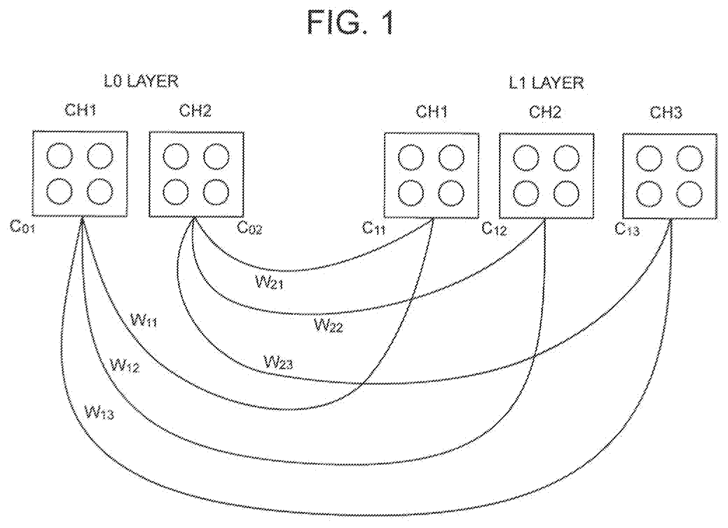

Each layer contains a plurality of channels. The L0 and L1 layers also contain a plurality of channels, respectively. FIG. 1 is a schematic diagram showing an example of multiple channels in the L0 and L1 layers.

In the example shown in FIG. 1, the L0 layer includes two channels CH1 and CH2. In addition, the L1 layer contains three channels CH1 to CH3. However, the number of channels in each layer is not limited to the example shown in FIG. 1.

The individual circles in FIG. 1 indicate values. The values in the L1 layer are values that are about to be calculated. It is assumed that the values have already been calculated for each channel in the L0 layer.

The set of values for each channel is referred to as the feature value group.

In the example shown in FIG. 1, in the L0 layer, the feature value group corresponding to channel CH1 is written as C₀₁, and the feature value group corresponding to channel CH2 is written as C₀₂. Similarly, in the L1 layer, the feature value group corresponding to channel CH1 is written as C₁₁, the feature value group corresponding to channel CH2 is written as C₁₂, and the feature value group corresponding to channel CH3 is written as C₁₃.

In order to calculate sets of feature values in the L1 layer, weights are determined by learning to the connections between the channels in the L1 layer and the channels in the L0 layer. The connection between the channels for which weights are determined is called edge. In the example shown in FIG. 1, an edge is defined between each channel in the L0 layer and each channel in the L1 layer. The number of edges in this example is six. In the example shown in FIG. 1, the weights defined for each of the six edges are W₁₁, W₁₂, W₁₃, W₂₁, W₂₂, and W₂₃.

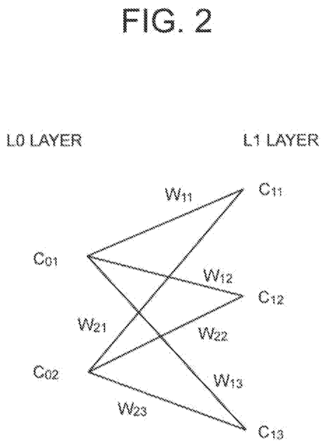

Each feature value group of the L1 layer is calculated by the weights and the feature value group of the L0 layer. FIG. 2 shows a schematic diagram of the values used to calculate each feature value group in the L1 layer.

The feature value group C₁₁ corresponding to the channel CH1 of the L1 layer is calculated using the feature value group C₀₁, the weight W₁₁, the feature value group C₀₂, and the weight W₂₁ (refer to FIG. 1 and FIG. 2).

Similarly, the feature value group C₁₂ corresponding to the channel CH2 of the L1 layer is calculated using the feature value group C₀₁, the weight W₁₂, the feature value group C₀₂, and the weight W₂₂ (refer to FIG. 1 and FIG. 2).

Similarly, the feature value group C₁₃ corresponding to the channel CH3 of the L1 layer is calculated using the feature value group C₀₁, the weight W₁₃, the feature value group C₀₂, and the weight W₂₃ (refer to FIGS. 1 and 2).

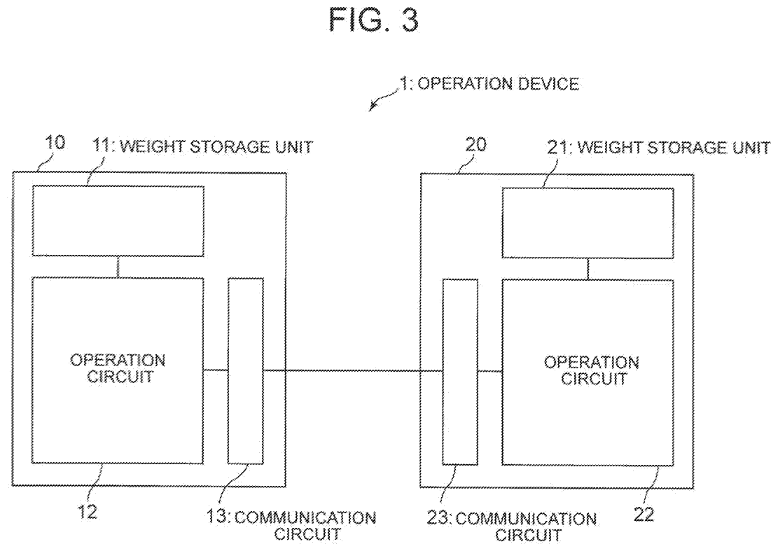

FIG. 3 is a block diagram of an example of an operation device that performs neural network operations with multiple chips. The operation device 1 comprises a plurality of chips. In the following, for the sake of simplicity, the case where the number of chips is two will be used as an example. In FIG. 3, the case where the operation device 1 comprises two chips 10, 20 is also illustrated. However, the operation device 1 may comprise three or more chips.

The chip 10 comprises a weight storage unit 11, an operation circuit 12, and a communication circuit 13.

Similarly, the chip 20 comprises a weight storage unit 21, an operation circuit 22, and a communication circuit 23.

The weight storage units 11, 21 is realized by a memory in the chip. The operation circuits 12, 22 are realized by a processor in the chip. The communication circuits 13, 23 are realized by a communication interface for inter-chip communication.

Here, the case of calculating the feature value group of the L1 layer from the feature value group of the L0 layer will be used as an example. The operation method between the other layers may be the same as the operation method for calculating the feature value group of the L1 layer from the feature value group of the L0 layer.

The operation circuits 12, 22 calculate the feature value group of the L1 layer from the feature value group of the L0 layer.

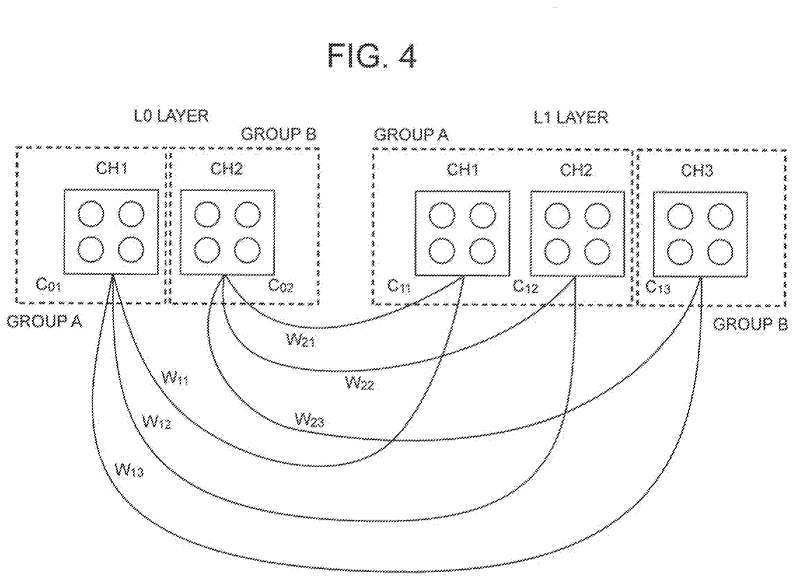

It is assumed that channels of the L0 layer and channels of the L1 layer is, respectively, divided into groups whose number is equal to the number of the chips (2 in this example) that are included in the operation device 1. The number of channels belonging to one group may be 0 or 1. FIG. 4 shows an example where the channels CH1 and CH2 of the L0 layer and the channels CH1 to CH3 of the L1 layer shown in FIG. 1 are divided into groups with the same number of chips. However, the way of grouping is not limited to the example shown in FIG. 4. As illustrated in FIG. 4, in the L0 and L1 layers, channels are divided into two groups A and B. In the example shown in FIG. 4, channel CH1 of the L0 layer belongs to group A of the L0 layer, and channel CH2 of the L0 layer belongs to group B of the L0 layer. The channels CH1 and CH2 of the L1 layer belong to group A of the L1 layer, and the channel CH3 of the L1 layer belong to group B of the L1 layer.

In addition, groups of channels in the L0 layer, groups of channels in the L1 layer, and chips are associated. In this example, it is assumed that group A of the L0 layer, group A of the L1 layer and chip 10 is associated, and group B of the L0 layer, group B of the L1 layer and chip 20 is associated.

It is assumed that the weight storage unit 11 in the chip 10 stores weights W₁₁, W₁₂, W₂₁, and W₂₂ of the edges connecting the channels CH1 and CH2 belonging to the group A of the L1 layer corresponding to the chip 10 and each channel of the L0 layer. Similarly, the weight storage unit 21 in the chip 20 shall store the weights W₁₃ and W₂₃ of the edges connecting the channel CH3 belonging to the group B of the L1 layer corresponding to the chip 20 and each channel of the L0 layer.

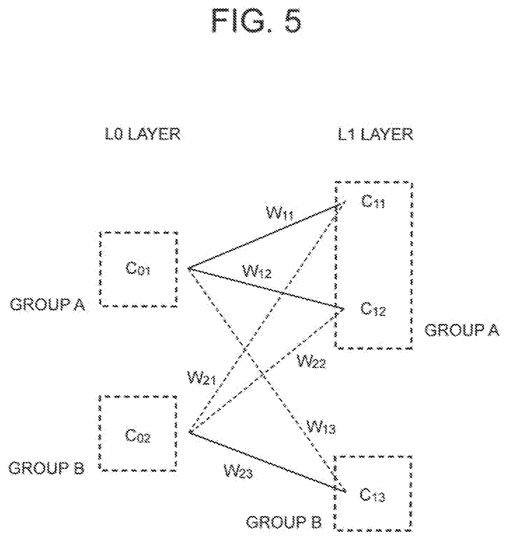

The operation circuit 12 in the chip 10 calculates the feature value groups C₁₁ and C₁₂ of channels CH1 and CH2 belonging to group A of the L1 layer corresponding to the chip 10. The operation circuit 22 in the chip 20 calculates the feature value group C₁₃ of channel CH3 belonging to group B of the L1 layer corresponding to the chip 20. However, in this example, data communication is required between the chips 10, 20. FIG. 5 is a schematic diagram showing the feature value groups of the L0 layer that are transmitted and received between the chips 10, 20 for the calculation of the feature value groups of the channels of the L1 layer in this example. In FIG. 5, the feature value groups of channels of the L1 layer and the feature value groups of the L0 layer that are transmitted and received between the chips 10, 20 for the calculation of the feature value groups are illustrated by connected by dashed lines.

The operation circuit 12 in the chip 10 calculates the feature value group C₁₁ using the feature value group C₀₁, weight W₁₁, feature value group C₀₂, and weight W₂₁ (refer to FIGS. 4 and 5). Since the feature value group C₀₂ is held in the operation circuit 22 in the chip 20, the operation circuit 12 receives the feature value group C₀₂ from the chip 20 through the communication circuit 13 and calculates the feature value group C₁₁ using the feature value group C₀₂.

The operation circuit 12 in the chip 10 calculates the feature value group C₁₂ using the feature value group C₀₁, the weight W₁₂, the feature value group C₀₂, and the weight W₂₂ (refer to FIGS. 4 and 5). The operation circuit 12 receives this feature value group C₀₂ from the chip 20, as described above.

The operation circuit 22 in the chip 20 calculates the feature value group C₁₃ using the feature value group C₀₁, the weight W₁₃, the feature value group C₀₂, and the weight W₂₃ (refer to FIGS. 4 and 5). Since the feature value group C₀₁ is held in the operation circuit 12 in the chip 10, the operation circuit 22 receives the feature value group C₀₁ from the chip 10 through the communication circuit 23 and calculates the feature value group C₁₃ using the feature value group C₀₁.

As shown in FIG. 1, if each channel in the L0 layer is connected to each channel in the L1 layer by an edge, the data obtained by data communication between chips must be used to calculate any of the feature value groups in the L1 layer, as described above. If the amount of data communication between chips increases in this way, the operation process of the neural network will become slower.

Each example embodiment of the present invention describes an assignment device that defines the edge between the L0 layer and the L1 layer so that the amount of data communication between chips can be suppressed, and also assigns weights to each chip in the operation device 1. As mentioned above, for the sake of simplicity of explanation, the case where the operation device 1 comprises two chips 10, 20 is used as an example, but the operation device 1 may comprise three or more chips.

### Example Embodiment 1

In the following explanation, it is assumed that the multiple channels in the L0 and L1 layers are represented as illustrated in FIG. 1. In other words, the L0 layer contains two channels CH1 and CH2, and the L1 layer contains three channels CH1 to CH3. However, the number of channels in each layer is not limited to the example shown in FIG. 1. In the initial state (in other words, before processing by the assignment device), each channel in the L0 layer is connected to each channel in the L1 layer by an edge. That is, in this example, the number of channels in the L0 layer is 2 and the number of channels in the L1 layer is 3, so in the initial state, there are 6 edges between the L0 and L1 layers (refer to FIG. 1). Also, in the initial state, the weights of each edge have not yet been learned. In other words, FIG. 1 illustrates the weights W₁₁, W₁₂, W₁₃, W₂₁, W₂₂, and W₂₃ for each edge, but in the initial state, these weights have not been learned.

Then, based on the channels in each of the L0 and L1 layers in the initial state, and each edge between the L0 and L1 layers in the initial state, the assignment device of the present example embodiment determines the weight of each edge, grouping of channels in the L0 layer, grouping of channels in the L1 layer, the association of the groups of the channels in the L0 layer and the groups of the channels in the L1 layer and the chips included in the operation device 1, and edges to be removed. The assignment device of the present example embodiment also removes the edges to be removed.

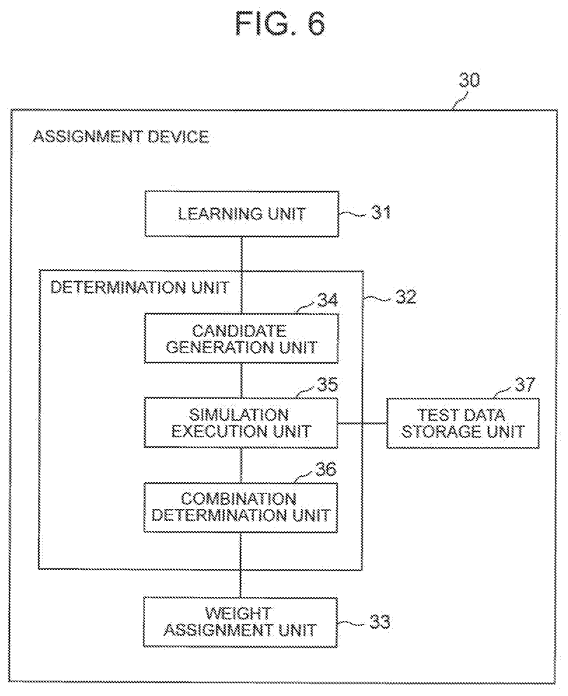

FIG. 6 shows a block diagram of an exemplary configuration of the assignment device of the first example embodiment of the present invention. The assignment device 30 of the first example embodiment of the present invention comprises a learning unit 31, a determination unit 32, a weight assignment unit 33, and a test data storage unit 37. The determination unit 32 comprises a candidate generation unit 34, a simulation execution unit 35, and a combination determination unit 36.

The learning unit 31 learns the weight of each edge that connects each channel in the L0 layer to each channel in the L1 layer. As mentioned above, in the example shown in FIG. 1, there are six edges between the L0 and L1 layers (refer to FIG. 1) in the initial state. The learning unit 31 learns the weight of each of these edges. As a result of learning, the weights W₁₁, W₁₂, W₁₃, W₂₁, W₂₂, and W₂₃ (refer to FIG. 1) for each edge are determined.

The method by which the learning unit 31 learns the weight of each edge may be any known method and is not limited. The learning unit 31 may learn the weights of each edge so that the weights of some edges (for example, a predetermined percentage of the number of edges) are as 0 or close to 0 as possible.

Using the results of learning the weights of each edge, the determination unit 32 divides the channels of the L0 layer and the channels of the L1 layer into groups whose number is equal to the number of the chips 10, 20 (2 in this example) included in the operation device 1 (refer to FIG. 3), respectively. In other words, the determination unit 32 divides the channels of the L0 layer into two groups and divides the channels of the L1 layer into two groups. Then, the determination unit 32 determines the association of the groups of the channels in the L0 layer and the groups of the channels in the L1 layer and the chips 10, 20 included in the operation device 1, and also determines the edges to be removed among the six edges between the L0 layer and the L1 layer. The determination unit 32 then removes the edges to be removed.

The following is a more specific description of the determination unit 32.

The candidate generation unit 34 included in the determination unit 32 generates a plurality of candidates for combination of the grouping of the channels in the L0 layer, the grouping of the channels in the L1 layer, the association of the groups of the channels in the L0 layer and the groups of the channels in the L1 layer and the chips, and edges to be removed. The number of channels belonging to one group may be 0 or 1.

However, the candidate generation unit 34 makes sure that the number of groups in any of the L0 and L1 layers in each candidate is the same as the number of chips included in the operation device 1.

When associating the groups of the channels in the L0 layer and the groups of the channels in the L1 layer and the chips, the association is determined so that one group of channels in the L0 layer is not associated to multiple groups of channels in the L1 layer or to multiple chips. The same is true for groups of channels in the L1 layer and chips. This is also the case in the second example embodiment described below.

There are more than one way to define each of “grouping of the channels in the L0 layer”, “grouping of the channels in the L1 layer”, “the association of the groups of the channels in the L0 layer and the groups of the channels in the L1 layer and the chips” and “edges to be removed”.

The candidate generation unit 34 may exhaustively generate candidates for combination of the grouping of the channels in the L0 layer, the grouping of the channels in the L1 layer, the association of the groups of the channels in the L0 layer and the groups of the channels in the L1 layer and the chips, and edges to be removed.

Alternatively, the candidate generation unit 34 may generate a plurality of candidates for combination under predetermined condition.

For example, the candidate generation unit 34 may identify predetermined number of edges in the order that the weights are close to 0, and generate a plurality of candidates for combination of the grouping of the channels in the L0 layer, the grouping of the channels in the L1 layer, the association of the groups of the channels in the L0 layer and the groups of the channels in the L1 layer and the chips, and edges to be removed, under the condition that the identified predetermined number of edges are defined as the edges to be removed.

For example, the candidate generation unit 34 may identify one edge whose weight is closest to 0, and generate a plurality of candidates for combination of the grouping of the channels in the L0 layer, the grouping of the channels in the L1 layer, the association of the groups of the channels in the L0 layer and the groups of the channels in the L1 layer and the chips, and edges to be removed, under the condition that the identified edge is defined as the edge to be removed.

The simulation execution unit 35 included in the determination unit 32 executes the simulation of the operation of the neural network in the operation device 1 for each candidate of the combination generated by the candidate generation unit 34. The simulation of the operation of the neural network is the simulation of the operation of sequentially calculating the feature value groups of the channels in each layer from the input layer to the output layer of the neural network and deriving the result in the output layer. Here, the candidate generation unit 34 focuses on the L0 layer and the L1 layer, and generates candidates for the combination of the grouping of the channels in the L0 layer, the grouping of the channels in the L1 layer, the association of the groups of the channels in the L0 layer and the groups of the channels in the L1 layer and the chips, and edges to be removed. The state of the neural network before the L0 layer and the state of the neural network after the L1 layer can be fixed by the simulation execution unit 35. In this way, by fixing the states of the neural networks other than those defined as candidates, it is possible to sequentially calculate the feature value groups of the channels in each layer from the input layer to the output layer and derive the results in the output layer.

The test data storage unit 37 is a storage device that stores a plurality of pairs of data input in the above simulation (hereinafter referred to as test data) and the correct answer data of the neural network operation corresponding to the test data. For example, suppose that the neural network operation outputs the estimation result of an object in an image. In this case, the pairs of the image and the data indicating the actual objects in the image can be used as the pairs of the test data and the correct answer data. In the following, the case where the result of the neural network operation is the estimated result of the objects in the image will be used as an example.

The simulation execution unit 35 sequentially selects the candidates one by one. Then, for the selected candidate, the simulation execution unit 35 sequentially calculates the feature value groups of the channels in each layer from the input layer to the output layer, using the individual test data (images) as input data respectively, and derives the estimation result of the object in the images. Then, the simulation execution unit 35 compares the estimation result with the correct answer data corresponding to the input data, and calculates the rate (i.e., the correct answer rate) of the number of correct answers of the estimation results (results obtained by simulation) to the number of pairs of test data and correct answer data.

For each selected candidate, the simulation execution unit 35 measures the number of test data (images) processed per second (in this example, Frame Per Second (FPS)) in the simulation, while sequentially calculating the feature value groups of the channels in each layer from the input layer to the output layer using the individual test data (images) as input data and deriving the estimation results of the objects in the images.

The simulation execution unit 35 then calculates the sum of the correct answer rate and the FPS for each selected candidate.

The correct answer rate is an index that indicates the accuracy of the operation for the selected candidate. The larger the value of the correct rate, the better the accuracy of the operation. The FPS is an index of the speed of the operation for the selected candidate. Therefore, it can be said that the sum of the correct answer rate and the FPS is an index that represents both the accuracy and the speed of the operation of the selected candidate. In other words, the greater the sum of the correct answer rate and the FPS, the better the overall accuracy of the operation and the faster the operation.

In addition, the fact that the amount of data communication between chips is small is one of the factors that makes the operation faster. Therefore, it can be said that if the sum of the correct answer rate and the FPS is large, the amount of data communication between chips tends to be small.

An index other than the “sum of the correct answer rate and the FPS” may be used as an index that represents both the accuracy of the operation and the speed of the operation. In the following description, the case where the simulation execution unit 35 calculates the sum of the correct answer rate and the FPS as an index that represents both the accuracy of the operation and the speed of the operation will be used as an example.

The combination determination unit 36 included in the determination unit 32 determines the combination that corresponds to the candidate with the largest sum of the correct answer rate and FPS as the combination of the grouping of the channels in the L0 layer, the grouping of the channels in the L1 layer, the association of the groups of the channels in the L0 layer and the groups of the channels in the L1 layer and the chips, and edges to be removed. As a result, the combination the grouping of the channels in the L0 layer, the grouping of the channels in the L1 layer, the association of the groups of the channels in the L0 layer and the groups of the channels in the L1 layer and the chips, and edges to be removed have been determined.

In addition, the combination determination unit 36 removes the edges to be removed included in that combination from edges between the L0 and L1 layers.

The weight assignment unit 33 stores the weights of the edges each connecting the channels of the L0 layer and the channels of the L1 layer in the weight storage unit in the chip corresponding to the edge, based on the combination determined by the combination determination unit 36. In other words, the weight assignment unit 33 causes the weight storage unit in the chip corresponding to the edge to store the weights of the edges that remain unremoved by the combination determination unit 36.

The following is an example of an operation in which the weight assignment unit 33 stores the weight of an edge in the weight storage unit in the chip corresponding to the edge. When the weight assignment unit 33 stores the weight of one edge in the weight storage unit, for example, it stores the weight of the edge in the weight storage unit in the chip corresponding to the group to which the L1 layer channel belongs among the L0 layer channel and L1 layer channel connected by that edge. For example, suppose that the edge connecting the channel CH1 of the L0 layer and the channel CH1 of the L1 layer shown in FIG. 1 is not removed and remains. Also suppose that the group to which the channel CH1 of the L1 layer belongs is associated with the chip 10. In this case, the weight assignment unit 33 stores the weight W₁₁ of that edge in the weight storage unit 11 in the chip 10 corresponding to the group to which channel CH1 of the L1 layer belongs. For example, suppose that the edge connecting the channel CH2 of the L0 layer and the channel CH3 of the L1 layer shown in FIG. 1 is not removed and remains. Also, suppose that the group to which the channel CH3 of the L1 layer belongs is associated with the chip 20. In this case, the weight assignment unit 33 stores the weight W₂₃ of that edge in the weight storage unit 21 in the chip 20 corresponding to the group to which channel CH3 of the L1 layer belongs.

However, the operation of storing the edge weights in the weight storage unit in the chip according to the edge is not limited to the above example, but may be other operations.

The weight assignment unit 33 comprises an interface (not shown in FIG. 6) with the individual chips 10, 20, and through that interface, it can access the weight storage units 11, 21 of the individual chips 10, 20 and store the weights in the weight storage units 11, 21.

The weight assignment unit 33 is realized by, for example, a CPU (Central Processing Unit) of a computer that operates according to an assignment program, and the interface of the computer (more specifically, the interface with the respective chips 10, 20 of the operation device 1. Hereinafter referred to as the chip interface). For example, the CPU may read the assignment program from a program recording medium such as a program storage device of the computer, and operate as the weight assignment unit 33 using the chip interface according to the assignment program.

The determination unit 32 including the candidate generation unit 34, the simulation execution unit 35, and the combination determination unit 36, and the learning unit 31 are realized by, for example, the CPU of the computer that operates according to the assignment program. For example, the CPU may read the assignment program from the program recording medium as described above, and operate as the determination unit 32 including the candidate generation unit 34, the simulation execution unit 35, and the combination determination unit 36, and the learning unit 31 according to the assignment program.

The test data storage unit 37 is realized by, for example, a storage device included in the computer.

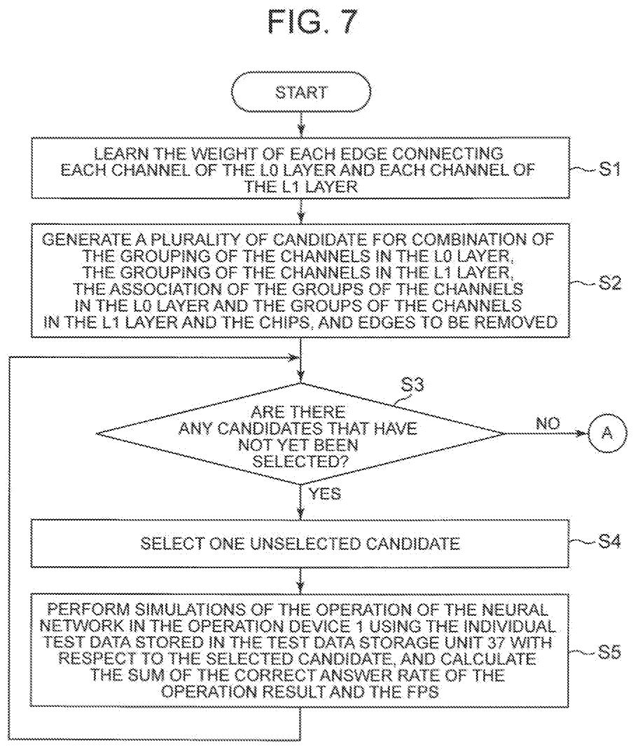

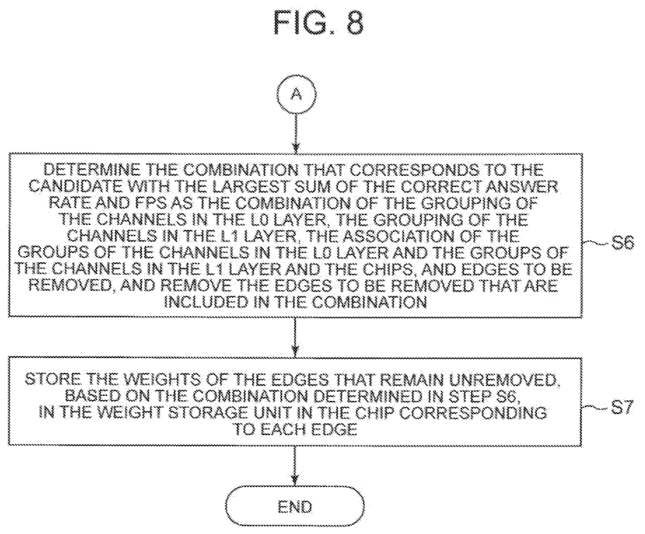

Next, the processing progress will be explained. FIGS. 7 and 8 are flowcharts showing examples of the processing progress of the assignment device 30 of the first example embodiment. The matters already explained are omitted as appropriate.

As mentioned above, it is assumed that the multiple channels in the L0 and L1 layers are represented as illustrated in FIG. 1. In the initial state, each channel in the L0 layer and each channel in the L1 layer are connected to each other by edges. In the initial state, the weights of the edges connecting each channel in the L0 layer to each channel in the L1 layer are not defined.

First, the learning unit 31 learns the weight of each edge connecting each channel of the L0 layer and each channel of the L1 layer (Step S1). As a result of Step S1, the weights W₁₁, W₁₂, W₁₃, W₂₁, W₂₂, W₂₃ (refer to FIG. 1) of each edge are determined.

Next, the candidate generation unit 34 generates a plurality of candidate for combination of the grouping of the channels in the L0 layer, the grouping of the channels in the L1 layer, the association of the groups of the channels in the L0 layer and the groups of the channels in the L1 layer and the chips, and edges to be removed (Step S2).

In step S2, the candidate generation unit 34 may identify predetermined number of edges in the order that the weights are close to 0, and generate a plurality of candidates, under the condition that the identified predetermined number of edges are defined as the edges to be removed.

In step S2, the candidate generation unit 34 may identify one edge whose weight is closest to 0, and generate a plurality of candidates, under the condition that the identified edge is defined as the edge to be removed.

In step S2, the candidate generation unit 34 may generate a plurality of candidates exhaustively.

Next to Step S2, the simulation execution unit 35 determines whether there are any candidates that have not yet been selected in Step S4 among the candidates generated in Step S2 (Step S3). If there is a candidate that has not yet been selected in Step S4 (Yes in Step S3), the process moves to Step S4. When moving from Step S2 to Step S3, since none of the candidates have been selected yet, the process moves to Step S4.

In step S4, the simulation execution unit 35 selects one unselected candidate among the candidates generated in step S2.

Next to step S4, the simulation execution unit 35 performs a simulation of the operation of the neural network in the operation device 1 using the individual test data stored in the test data storage unit 37 with respect to the selected candidate. Further, the simulation execution unit 35 calculates the sum of the correct answer rate of the operation result in the simulation and the FPS in the simulation (step S5).

After step S5, repeat the process from step S3 onward.

In step S3, if the simulation execution unit 35 determines that there are no unselected candidates (No in step S3), it moves to step S6 (refer to FIG. 8).

In step S6, the combination determination unit 36 determines the combination that corresponds to the candidate with the largest sum of the correct answer rate and FPS as the combination of the grouping of the channels in the L0 layer, the grouping of the channels in the L1 layer, the association of the groups of the channels in the L0 layer and the groups of the channels in the L1 layer and the chips, and edges to be removed. In addition, the combination determination unit 36 removes the edges to be removed that are included in the combination.

As a result of step S6, the grouping of the channels in the L0 layer, the grouping of the channels in the L1 layer, the association of the groups of the channels in the L0 layer and the groups of the channels in the L1 layer and the chips are determined, and the edges to be removed are removed.

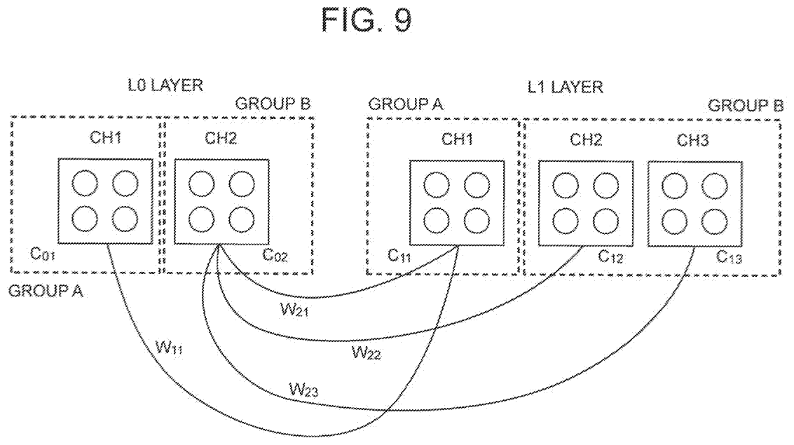

FIG. 9 shows an example of the result of step S6. In the example shown in FIG. 9, in the L0 layer, channel CH1 belongs to group A and channel CH2 belongs to group B. In the L1 layer, channel CH1 belongs to group A and channels CH2, CH3 belong to group B. In both the L0 and L1 layers, the number of groups is the same as the number of the chips 10, 20 (i.e., 2) included in the operation device 1. It is also assumed that group A in the L0 layer and group A in the L1 layer and chip 10 (refer to FIG. 3) are associated, and that group B in the L0 layer and group B in the L1 layer and chip 20 are associated. In the example shown in FIG. 9, the edge connecting the channel CH1 of the L0 layer and the channel CH2 of the L1 layer and the edge connecting the channel CH1 of the L0 layer and the channel CH3 of the L1 layer have been removed.

As a result of step S6, the above state is assumed to be defined.

After step S6, the weight assignment unit 33 stores the weights of the edges that remain unremoved, based on the combination determined in step S6, in the weight storage unit in the chip corresponding to each edge (step S7).

When storing the weight of one edge in the weight storage unit, for example, the weight assignment unit 33 stores the weight of the edge in the weight storage unit in the chip corresponding to the group to which the L1 layer channel belongs among the L0 layer channel and L1 layer channel connected by that edge. For example, in this example, the weight assignment unit 33 stores the weights W₁₁ and W₂₁ in the weight storage unit 11 in the chip 10 corresponding to the group A to which the channel CH1 of the L1 layer belongs. The weight assignment unit 33 stores the weight W₂₂ in the weight storage unit 21 in the chip 20 corresponding to the group B to which the channel CH2 of the L1 layer belongs. The weight assignment unit 33 stores the weight W₂₃ in the weight storage unit 21 in the chip 20 corresponding to the group B to which the channel CH3 of the L1 layer belongs.

Next, the operation in which the operation device 1, which has stored the weights as described above, calculates the feature value groups of the L1 layer from the feature value groups of the L0 layer is explained. It is assumed that the states of the neural network before the L0 layer and after the L1 layer are also defined.

The operation circuit 12 (refer to FIG. 3) calculates the feature value group C₀₁ corresponding to the channel CH1 of the L0 layer. The operation circuit 22 calculates the feature value group C₀₂ corresponding to the channel CH2 of the L0 layer.

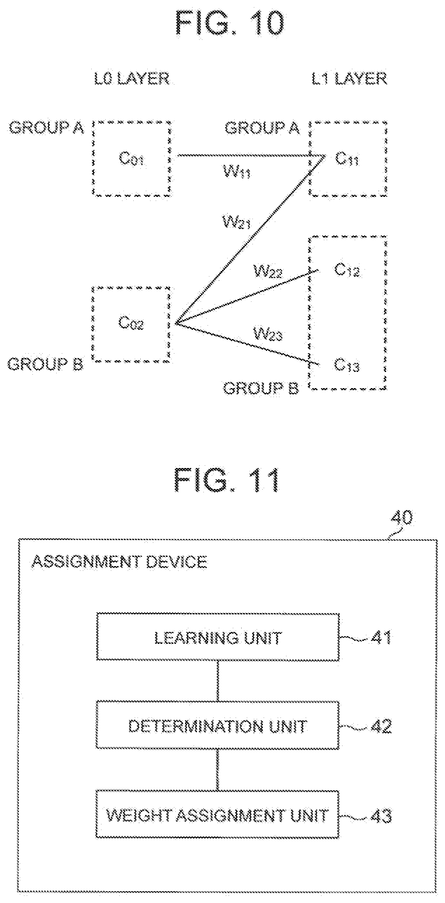

FIG. 10 shows a schematic diagram of the values used to calculate each feature value group in the L1 layer, in the example shown in FIG. 9.

The operation circuit 12 calculates the feature value group C₁₁ corresponding to the channel CH1 of the L1 layer using the feature value group C₀₁, the weight W₁₁, the feature value group C₀₂, and the weight W₂₁ (refer to FIG. 10). Here, the feature value group C₀₂ is held in the operation circuit 22 in the chip 20. Therefore, the operation circuit 12 obtains the feature value group C₀₂ from the operation circuit 22 in the chip 20. For example, the operation circuit 12 requests the feature value group C₀₂ to the chip 20 through the communication circuit 13. When the operation circuit 22 in the chip 20 receives the request through the communication circuit 23, it transmits the feature value group C₀₂ to the chip 10 through the communication circuit 23. The operation circuit 12 can receive the feature value group C₀₂ through the communication circuit 13.

The operation circuit 12 then calculates the feature value group C₁₁ by using the feature value group C₀₁, weight W₁₁, feature value group C₀₂, and weight W₂₁ as described above.

The operation circuit 22 calculates the feature value group C₁₂ corresponding to the channel CH2 of the L1 layer using the feature value group C₀₂ and the weights W₂₂ (refer to FIG. 10). Since the operation circuit 22 holds the feature value group C₀₂, it can calculate the feature value group C₁₂ without receiving any data from the chip 10.

Similarly, the operation circuit 22 calculates the feature value group C₁₃ corresponding to the channel CH3 of the L1 layer using the feature value group C₀₂ and the weights W₂₃ (refer to FIG. 10). Since the operation circuit 22 holds the feature value group C₀₂, it can calculate the feature value group C₁₃ without receiving any data from the chip 10.

The operation circuits 12, 22 sequentially calculate the feature value groups for each layer after the L1 layer.

As described above, the operation device 1 may perform data communication between chips in order to calculate some feature value groups of the L1 layer (feature value group C₁₁ in the above example). However, it is not necessary to perform data communication every time all feature value groups of the L1 layer are calculated respectively. Therefore, the operation speed in the operation device 1 can be accelerated.

In other words, in the present example embodiment, the candidate generation unit 34 generates a plurality of candidates for combinations. Then, the simulation execution unit 35 executes a simulation of the operation of the neural network in the operation device 1 for each candidate, and calculates the sum of the correct answer rate and the FPS (an index representing both the accuracy of the operation and the speed of the operation). Then, the combination determination unit 36 determines the combination corresponding to the candidate with the largest sum of the correct answer rate and the FPS, and removes the edges to be removed included in the combination. Then, the weight assignment unit 33 stores the weights of the edges that remain unremoved based on the combination in the weight storage unit in the chip corresponding to the edge. Thus, according to the present example embodiment, the edges between neighboring layers can be defined so that the amount of data communication between chips can be suppressed, and weights can be assigned to the chips of the operation device that executes the operation of the neural network by a plurality of chips.

In the present example embodiment, the learning unit 31 may re-learn the weights of the edges that remain unremoved after step 6.

For each neighboring layers, the assignment device 30 may determine the combination of the grouping of the channels in the L0 layer, the grouping of the channels in the L1 layer, the association of the groups of the channels in the L0 layer and the groups of the channels in the L1 layer and the chips, and edges to be removed, and remove the edges to be removed.

The candidate generation unit 34 may generate a plurality of candidates for the combination of grouping of the channels in each layer, association of the groups of the channels of each layer and the chips, and edges to be removed, from the input layer to the output layer as a whole. Then, the simulation execution unit 35 may performs a simulation of the operation for each candidate and calculate the sum of the correct answer rate and the FPS. Then, the combination determination unit 36 may determine the combination corresponding to the candidate with the largest sum of the correct answer rate and the FPS, and remove the edge to be removed included in that combination.

### Example Embodiment 2

In the second example embodiment, it is also assumed that the plural channels in the L0 and L1 layers are represented as illustrated in FIG. 1. In other words, the L0 layer contains two channels CH1 and CH2, and the L1 layer contains three channels CH1 to CH3. However, the number of channels in each layer is not limited to the example shown in FIG. 1. In the initial state (in other words, before processing by the assignment device), each channel in the L0 layer is connected to each channel in the L1 layer by an edge. That is, in this example, the number of channels in the L0 layer is 2 and the number of channels in the L1 layer is 3, so in the initial state, there are 6 edges between the L0 and L1 layers (refer to FIG. 1). Also, in the initial state, the weights of each edge have not yet been learned. In other words, FIG. 1 illustrates the weights W₁₁, W₁₂, W₁₃, W₂₁, W₂₂, and W₂₃ for each edge, but in the initial state, these weights have not been learned.

FIG. 11 shows a block diagram of an exemplary configuration of the assignment device of the second example embodiment of the present invention. The assignment device 40 of the second example embodiment of the present invention comprises a learning unit 41, a determination unit 42, and a weight assignment unit 43.

The learning unit 41 learns the weight of each edge that connects each channel in the L0 layer to each channel in the L1 layer. At this time, the learning unit 41 learns the weights of each edge so that the weights of a predetermined percentage of the number of edges among those edges are as 0 or close to 0 as possible. However, it does not necessarily mean that the weights learned to be as 0 or close to 0 as possible will be such values. For example, even if the weights of an edge are learned to be as 0 or close to 0 as possible, the result may be that the weight of that edge becomes a value such as “5”.

In the example shown in FIG. 1, in the initial state, there are six edges between the L0 and L1 layers. In addition, it is assumed that the predetermined percentage above is “⅓”; the number of ⅓ of 6 edges is 2. Therefore, in this example, the learning unit 41 learns the weights of each of the six edges so that the weights of the two edges are as 0 or close to 0 as possible. The method of selecting a predetermined percentage of the number of edges (two in this example) is not limited. In this example, the case where the above two edges are the edge connecting channel CH1 of the L0 layer and channel CH3 of the L1 layer, and the edge connecting channel CH2 of the L0 layer and channel CH1 of the L1 layer is described. In this case, the weights W₁₃ and W₂₁ are likely to be 0 or close to 0 as a result of learning, but it is also possible that they will not be such values. In the following, for the sake of simplicity, it is assumed that the weights W₁₃ and W₂₁ are both close to 0 (for example, 0.01) as a result of learning.

The learning unit 41 may learn the weight of each edge so that the weight of each edge is as 0 or close to 0 as possible. However, in this learning, not all the edge weights will be 0 or close to 0.

The determination unit 42 compares the weight of each edge obtained by learning with a predetermined threshold value, and removes the edges whose weight is equal to or less than the threshold value. This threshold value is a threshold value for distinguishing weights with values of 0 or close to 0 from those without, and is defined as a value that is relatively close to 0. In this example, weights W₁₃ and W₂₁ are equal to or less than the threshold value. The other weights W₁₁, W₁₂, W₂₂, and W₂₃ are larger than the threshold value. Therefore, the determination unit 42 removes the edge connecting the channel CH1 of the L0 layer and the channel CH3 of the L1 layer, and the edge connecting the channel CH2 of the L0 layer and the channel CH1 of the L1 layer (refer to FIG. 1), and leaves the other four edges.

The determination unit 42 divides the channels of the L01 layer and the channels of the L1 layer into groups whose number is equal to the number of the chips 10, 20 (2 in this example) included in the operation device 1 (refer to FIG. 3), respectively. In other words, the determination unit 42 divides the channels of the L0 layer into two groups and divides the channels of the L1 layer into two groups. The number of channels belonging to one group may be 0 or 1. Furthermore, the determination unit 42 determines the association of the groups of channels in the L0 layer and the groups of channels in the L1 layer and the chips 10, 20 included in the operation device 1.

However, the determination unit 42 determines the grouping of the channels in the L0 layer, the grouping of the channels in the L1 layer, and the association of the groups of the channels in the L0 layer and the groups of the channels in the L1 layer and the chips so that a condition that the channels, connected by the removed edges, in the L0 layer and in the L1 layer, belong to non-corresponding groups of channels in the L0 layer and in the L1 layer respectively, is satisfied. The “non-corresponding groups of channels in the L0 layer and in the L1 layer” can also be expressed as “groups of channels in the L0 layer and in the L1 layer not corresponding to the same chip”.

In the above example, the determination unit 42 removes the edge connecting the channel CH1 of the L0 layer and the channel CH3 of the L1 layer, and the edge connecting the channel CH2 of the L0 layer and the channel CH1 of the L1 layer. Thus, in this case, the determination unit 42 determines the grouping of the channels in the L0 layer, the grouping of the channels in the L1 layer, and the association of the groups of the channels in the L0 layer and the groups of the channels in the L1 layer and the chips so that the condition that the channel CH1 of the L0 layer and the channel CH3 of the L1 layer belong to non-corresponding groups and the channel CH2 of the L0 layer and the channel CH1 of the L1 layer belong to non-corresponding groups is satisfied.

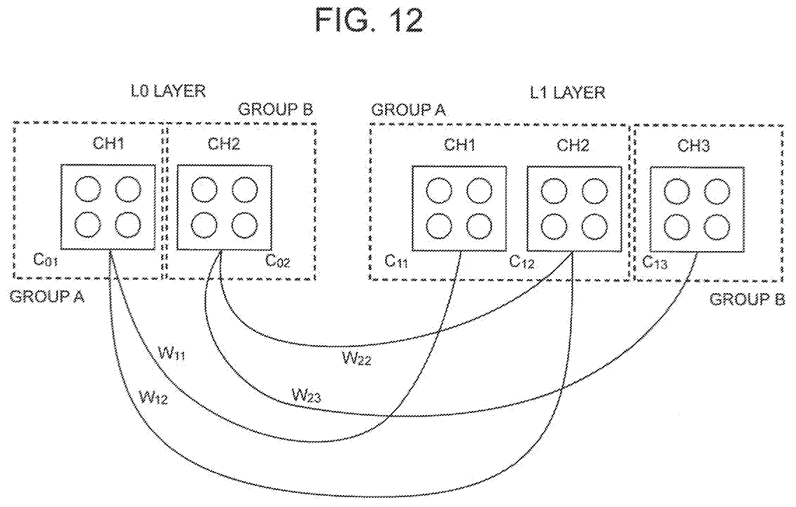

An example of the grouping and association that satisfy the above condition is shown in FIG. 12. In the example shown in FIG. 12, in the L0 layer, the channel CH1 belongs to the group A, and the channel CH2 belongs to the group B. In the L1 layer, the channels CH1, CH2 belong to the group A, and the channel CH3 belongs to the group B. In both the L0 and L1 layers, the number of the groups is the same as the number of the chips 10, 20 (i.e., 2) included in the operation device 1. It is also assumed that the group A of the L0 layer and the group A of the L1 layer and the chip 10 (refer to FIG. 3) are associated, and that the group B of the L0 layer and the group B of the L1 layer and the chip 20 are associated. In this example, the group to which the channel CH1 of the L0 layer and the group to which the channel CH3 of the L1 layer are not associated, and the group to which the channel CH2 of the L0 layer and the group to which the channel CH1 of the L1 layer are not associated.

There may be more than one grouping and result of association that satisfy the above condition. For example, in the example shown in FIG. 12, the grouping and association may be determined so that the channel CH2 of the L1 layer belongs to the group B of the L1 layer. Thus, when there are multiple patterns of grouping and association that satisfy the above condition, the determination unit 42 may determine any one of them. FIG. 12 illustrates an example of one pattern arbitrarily determined from among a plurality of patterns of grouping and association that satisfy the condition.

Also, for example, when the number of removed edges is large, there may be cases where there is no pattern of grouping and association that completely satisfies the condition that the channels, connected by the removed edges, in the L0 layer and in the L1 layer, belong to non-corresponding groups of channels in the L0 layer and in the L1 layer respectively. In such a case, the determination unit 42 gives priority to determining the grouping of the channels in the L0 layer, the grouping of the channels in the L1 layer, and the association of the groups of the channels in the L0 layer and the groups of the channels in the L1 layer and the chips, and allows the above condition to not be completely satisfied.

The weight assignment unit 43 stores the weights of the edges that connect the channel of the L0 layer and the channel of the L1 layer (more specifically, the edges that remain unremoved) in the weight storage unit in the chip corresponding to each edge.

The operation of storing the weight of an edge in the weight storage unit in the chip corresponding to the edge may be the same as the operation described in the first example embodiment. That is, when the weight assignment unit 43 stores the weight of one edge in the weight storage unit, for example, it stores the weight of the edge in the weight storage unit in the chip corresponding to the group to which the channel of the L1 layer belongs among the channel of the L0 layer and the channel of the L1 layer connected by that edge. For example, in the example shown in FIG. 12, the edge connecting the channel CH1 of the L0 layer and the channel CH1 of the L1 layer is not removed and remains. In this case, the weight assignment unit 43 stores the weight W₁₁ of that edge in the weight storage unit 11 in the chip 10 corresponding to the group A to which the channel CH1 of the L1 layer belongs. Similarly, the weight assignment unit 43 stores the weights of the other edges in the weight storage unit in the chip corresponding to the edge.

However, the operation of storing the weight of the edge in the weight storage unit in the chip according to the edge is not limited to the above example, but may be other operations.

The weight assignment unit 43 comprises an interface (chip interface, not shown in FIG. 11) with the individual chips 10, 20, and can access the weight storage units 11, 21 of the individual chips 10, 20 through the chip interface and store the weights in the weight storage units 11, 21.

The weight assignment unit 43 is realized by, for example, a CPU of a computer that operates according to an assignment program and a chip interface of the computer. For example, the CPU may read the assignment program from a program recording medium such as a program storage device of the computer, and operate as the weight assignment unit 43 using the chip interface according to the assignment program.

The learning unit 41 and the determination unit 42 are realized by, for example, the CPU of the computer that operates according to the assignment program. For example, the CPU may read the assignment program from the program recording medium as described above, and operate as the learning unit 41 and the determination unit 42 according to the assignment program.

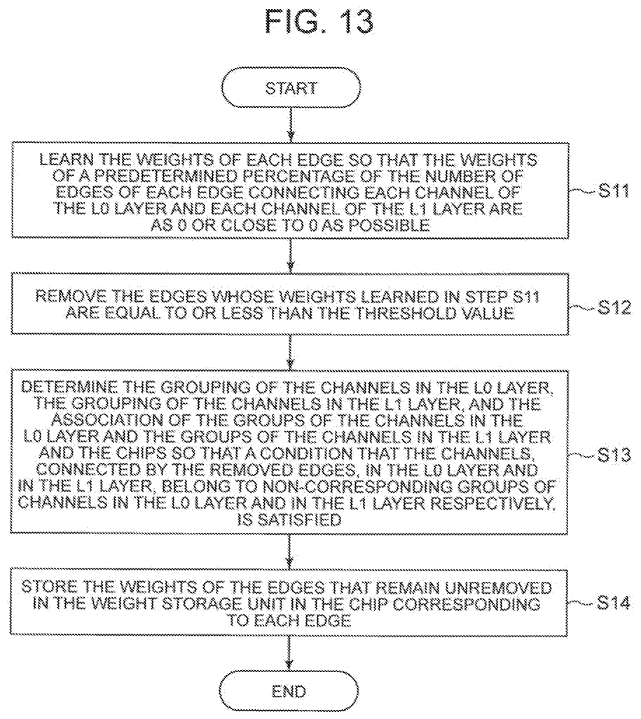

Next, the processing process will be explained. FIG. 13 is a flowchart showing an example of the processing process of the assignment device 40 of the second example embodiment. The matters already explained are omitted as appropriate.

As mentioned above, it is assumed that the multiple channels in the L0 and L1 layers are represented as illustrated in FIG. 1. In the initial state, each channel in the L0 layer and each channel in the L1 layer are connected to each other by edges. In the initial state, the weights of the edges connecting each channel in the L0 layer to each channel in the L1 layer are not defined.

First, the learning unit 41 learns the weights of each edge (each edge connecting each channel of the L0 layer and each channel of the L1 layer) so that the weights of a predetermined percentage of the number of edges each connecting each channel of the L0 layer and each channel of the L1 layer are as 0 or close to 0 as possible (Step S11).

Next, the determination unit 42 removes the edges whose weights learned in step S11 are equal to or less than the threshold value (step S12). This threshold value is a threshold value for distinguishing weights with values of 0 or close to 0 from those without. This threshold value is predetermined as a value that is relatively close to 0. Therefore, in step S12, edges with weights defined as 0 or close to 0 are removed.

However, regarding edges where the weights are learned to be as 0 or close to 0 as possible, it is not always the case that such a value of weight is obtained as a result of learning. Therefore, even edges whose weights are learned to be as 0 or close to 0 as possible in step S11 are not necessarily removed in step S12.

Next to step S12, the determination unit 42 determines the grouping of the channels in the L0 layer, the grouping of the channels in the L1 layer, and the association of the groups of the channels in the L0 layer and the groups of the channels in the L1 layer and the chips so that a condition that the channels, connected by the removed edges removed in step S12, in the L0 layer and in the L1 layer, belong to non-corresponding groups of channels in the L0 layer and in the L1 layer respectively, is satisfied (Step S13).

In step S13, the determination unit 42 divides the channels of the L01 layer and the channels of the L1 layer into groups whose number is equal to the number of the chips 10, 20 (2 in this example) included in the operation device 1 (refer to FIG. 3), respectively.

When there are multiple patterns of grouping and association that satisfy the above conditions, the determination unit 42 may determine any one of them.

The result of step S13 is represented, for example, as illustrated in FIG. 12. Since FIG. 12 has already been explained, it will not be explained here. It is assumed that the group A of the L0 layer and the group A of the L1 layer and the chip 10 (refer to FIG. 3) are associated, and that the group B of the L0 layer and the group B of the L1 layer and the chip 20 are associated.

After step S13, the weight assignment unit 43 stores the weights of the edges that remain unremoved in the weight storage unit in the chip corresponding to each edge (step S14).

When storing the weight of one edge in the weight storage unit, for example, the weight assignment unit 33 stores the weight of the edge in the weight storage unit in the chip corresponding to the group to which the L1 layer channel belongs among the L0 layer channel and L1 layer channel connected by that edge. For example, in the example shown in FIG. 12, the weight assignment unit 43 stores the weight W₁₁ in the weight storage unit 11 in the chip 10 corresponding to the group A to which the channel CH1 of the L1 layer belongs. Similarly, the weight assignment unit 43 stores the weights W₁₂ and W₂₂ in the weight storage unit 11 in the chip 10 corresponding to the group A to which the channel CH2 of the L1 layer belongs. The weight assignment unit 43 stores the weight W₂₃ in the weight storage unit 21 in the chip 20 corresponding to the group B to which the channel CH3 of the L1 layer belongs.

Next, the operation for calculating the feature value groups of the L1 layer from the feature value groups of the L0 layer, performed by the operation device 1 which has stored the weights as described above, is explained. It is assumed that the states of the neural network before the L0 layer and after the L1 layer are also defined.

The operation circuit 12 (refer to FIG. 3) calculates the feature value group C₀₁ corresponding to the channel CH1 of the L0 layer. The operation circuit 22 calculates the feature value group C₀₂ corresponding to the channel CH2 of the L0 layer.

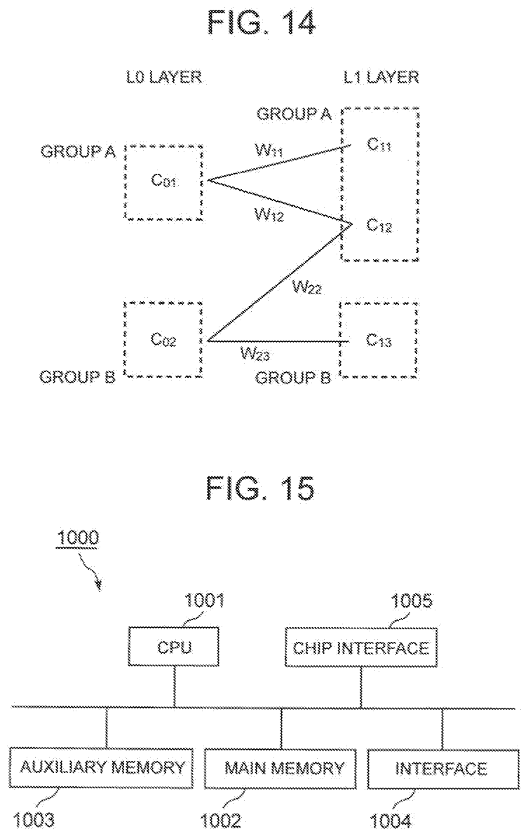

FIG. 14 shows a schematic diagram of the values used to calculate each feature value group in the L1 layer, in the example shown in FIG. 12.

The operation circuit 12 calculates the feature value group C₁₁ corresponding to the channel CH1 of the L1 layer using the feature value group C₀₁ and the weights W₁₁ (refer to FIG. 14). Since the operation circuit 12 holds the feature value group C₀₁, it can calculate the feature value group C₁₁ without receiving any data from the chip 20.

The operation circuit 12 calculates the feature value group C₁₂ corresponding to the channel CH2 of the L1 layer using the feature value group C₀₁, the weight W₁₂, the feature value group C₀₂, and the weight W₂₂ (refer to FIG. 14). Here, the feature value group C₀₂ is held in the operation circuit 22 in the chip 20. Therefore, the operation circuit 12 obtains the feature value group C₀₂ from the operation circuit 22 in the chip 20. For example, the operation circuit 12 requests the feature value group C₀₂ to the chip 20 through the communication circuit 13. When the operation circuit 22 in the chip 20 receives the request through the communication circuit 23, it transmits the feature value group C₀₂ to the chip 10 through the communication circuit 23. The operation circuit 12 may receive the feature value group C₀₂ through the communication circuit 13.

The operation circuit 12 then calculates the feature value group C₁₂ by using the feature value group C₀₁, weight W₁₂, feature value group C₀₂, and weight W₂₂ as described above.

The operation circuit 22 calculates the feature value group C₁₃ corresponding to the channel CH3 of the L1 layer using the feature value group C₀₂ and the weights W₂₃ (refer to FIG. 14). Since the operation circuit 22 holds the feature value group C₀₂, it can calculate the feature value group C₁₃ without receiving any data from the chip 10.

The operation circuits 12, 22 sequentially calculate the feature value groups for each layer after the L1 layer.

As described above, the operation device 1 may perform data communication between chips in order to calculate some feature value groups of the L1 layer (feature value group C₁₂ in the above example). However, it is not necessary to perform data communication every time all feature value groups of the L1 layer are calculated respectively. Therefore, the operation speed in the operation device 1 can be accelerated.

In other words, in the present embodiment, the learning unit 41 learns the weights of each edge so that the weights of a predetermined percentage of the number of edges are as 0 or close to 0 as possible. Then, the determination unit 42 removes the edges whose weights are equal to or less than the threshold value. In addition, the determination unit 42 determines the grouping of the channels in the L0 layer, the grouping of the channels in the L1 layer, and the association of the groups of the channels in the L0 layer and the groups of the channels in the L1 layer and the chips so that a condition that the channels, connected by the removed edges, in the L0 layer and in the L1 layer, belong to non-corresponding groups of channels in the L0 layer and in the L1 layer respectively, is satisfied. In this way, after removing the edges, the grouping and association are performed to satisfy the condition that the channels, connected by the removed edges, in the L0 layer and in the L1 layer, belong to non-corresponding groups of channels in the L0 layer and in the L1 layer respectively. As a result, the number of edges connecting channels that belong to non-corresponding groups is reduced. Therefore, according to this example embodiment, the edges between neighboring layers can be defined so that the amount of data communication between chips can be suppressed, and weights can be assigned to the chips of the operation device that executes the neural network operation by multiple chips.

In the present example embodiment, the learning unit 41 may re-learn the weights of the edges that remain unremoved after step S12.

For each neighboring layers, the assignment device 40 may remove some edges between the L0 and L1 layers, and determine the grouping of the channels in the L0 layer, the grouping of the channels in the L1 layer, and the association of the groups of the channels in the L0 layer and the groups of the channels in the L1 layer and the chips, using the method described in the second example embodiment.

Channel shuffling may be applied to the first and second example embodiments.

FIG. 15 shows a schematic block diagram of a exemplary configuration of a computer for the assignment devices 30, 40 of each example embodiment of the present invention. The computer 1000 has a CPU 1001, a main memory 1002, an auxiliary memory 1003, an interface 1004, and a chip interface 1005. The chip interface 1005 is an interface to the respective chips 10, 20 included in the operation device 1 (refer to FIG. 3).

The assignment devices 30, 40 of each example embodiment of the present invention are realized by the computer 1000. The operations of the assignment devices 30, 40 are stored in the auxiliary memory 1003 in the form of an assignment program. The CPU 1001 reads the assignment program from the auxiliary memory 1003, deploys it to the main memory 1002, and executes the processes described in each of the above example embodiments in accordance with the assignment program.

The auxiliary memory 1003 is an example of a non-transitory tangible medium. Other examples of non-transitory tangible media are a magnetic disk, an optical magnetic disk, a CD-ROM (Compact Disk Read Only Memory), a DVD-ROM (Digital Versatile Disk Read Only Memory), a semiconductor memory, and the like, which are connected through the interface 1004. When the program is delivered to the computer 1000 through a communication line, the computer 1000 that receives the delivery may deploy the program into the main memory 1002 and execute the processing described in each of the above example embodiments according to the program.

Some or all of the components of the assignment device may be realized by general-purpose or dedicated circuitry, processors, or a combination of these. They may be configured by a single chip or by multiple chips connected through a bus. Some or all of the components may be realized by a combination of the above-mentioned circuits, etc. and a program.

If some or all of the components of the assignment device are realized by multiple information processing devices, circuits, etc., the multiple information processing devices, circuits, etc. may be centrally located or distributed. For example, the information processing devices, circuits, etc. may be realized as a client-and-server system, cloud computing system, etc., each of which is connected through a communication network.

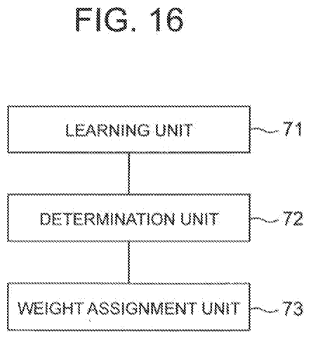

FIG. 16 shows a block diagram of an over view of the assignment device of the present invention. The assignment device of the present invention comprises a learning unit 71, a determination unit 72, and a weight assignment unit 73.

The learning unit 71 (for example, learning unit 31, 41) learns a weight for each edge connecting a channel in a first layer (for example, L1 layer) that is a layer in a neural network, and a channel in a 0th layer (for example, L0 layer) which is a previous layer to the first layer.

The determination unit 72 (for example, determination units 32, 42) divides channels in the 0th layer and channels in the first layer into groups whose number is equal to the number of chips (for example, chips 10, 20) that are included in an operation device (for example, operation device 1) executing an operation of the neural network using a learning result of the weight for each edge, respectively, determines association of the groups of the channels in the 0th layer and the groups of the channels in the first layer and the chips included in the operation device, and edges to be removed, and removes the edges to be removed.

The weight assigning unit 73 (for example, weight assigning unit 33, 43) stores the weights for the edges each connecting the channel in the 0th layer and the channel in the first layer to a weight storage unit in the chip corresponding to the edge.

According to such a configuration, the edges between neighboring layers can be defined so that the amount of data communication between chips can be suppressed, and weights can be assigned to the chips of the operation device that performs the neural network operations by a plurality of chips.

The aforementioned example embodiments of the present invention can be described as supplementary notes mentioned below, but are not limited to the following supplementary notes.

(Supplementary note 1) An assignment device comprising:
a learning unit which learns a weight for each edge connecting a channel in a first layer that is a layer in a neural network, and a channel in a 0th layer which is a previous layer to the first layer,
a determination unit which divides channels in the 0th layer and channels in the first layer into groups whose number is equal to the number of chips that are included in an operation device executing an operation of the neural network using a learning result of the weight for each edge, respectively, determines association of the groups of the channels in the 0th layer and the groups of the channels in the first layer and the chips included in the operation device, and edges to be removed, and removes the edges to be removed, and
a weight assignment unit which stores the weights for the edges each connecting the channel in the 0th layer and the channel in the first layer to a weight storage unit in the chip corresponding to the edge.

(Supplementary note 2) The assignment device according to supplementary note 1,
wherein
the determination unit includes:
   a candidate generation unit which generates a plurality of candidates for combination of grouping of the channels in the 0th layer, grouping of the channels in the first layer, the association of the groups of the channels in the 0th layer and the groups of the channels in the first layer and the chips, and edges to be removed,
   a simulation execution unit which executes a simulation of the operation of the neural network in the operation device for each of the candidates for combination and derives an index that represents both accuracy and speed of the operation, and
   a combination determination unit which determines the combination corresponding to the candidate with the highest index as the combination of the grouping of the channels in the 0th layer, the grouping of the channels in the first layer, the association of the groups of the channels in the 0th layer and the groups of the channels in the first layer and the chips, and edges to be removed, and removes edges to be removed included in determined combination, and
the weight assignment unit stores the weight for the edge connecting the channel in the 0th layer and the channel in the first layer to a weight storage unit in the chip corresponding to the edge, based on the combination determined by the combination determining unit.

(Supplementary note 3) The assignment device according to supplementary note 2, wherein
the candidate generation unit identifies predetermined number of edges in the order that the weights are close to 0, and generates a plurality of candidates for combination of the grouping of the channels in the 0th layer, the grouping of the channels in the first layer, the association of the groups of the channels in the 0th layer and the groups of the channels in the first layer and the chips, and edges to be removed, under the condition that the identified predetermined number of edges are defined as the edges to be removed.

(Supplementary note 4) The assignment device according to supplementary note 2, wherein
the candidate generation unit identifies an edge whose weight is closest to 0, and generates a plurality of candidates for combination of the grouping of the channels in the 0th layer, the grouping of the channels in the first layer, the association of the groups of the channels in the 0th layer and the groups of the channels in the first layer and the chips, and edges to be removed, under the condition that the identified edge is defined as the edge to be removed.

(Supplementary note 5) The assignment device according to supplementary note 1,
wherein
the learning unit learns the weights of each edge so that the weights of a predetermined percentage of the number of edges connecting the channels in the first layer to the channels in the 0th layer are as 0 or close to 0 as possible, and
the determination unit removes the edges whose weights learned by the learning unit are equal to or less than a threshold value, divides the channels in the 0th layer and the channels in the first layer into the groups whose number is equal to the number of chips that are included in the operation device so that a condition that the channels, connected by the removed edges, in the 0th layer and in the first layer, wherein the channels belong to non-corresponding groups of channels in the 0th layer and in the first layer respectively, is satisfied, and determines the association of the groups of the channels in the 0th layer and the groups of the channels in the first layer and the chips included in the operation device.

(Supplementary note 6) An assignment method, executed by a computer, comprising:
executing a learning process for learning a weight for each edge connecting a channel in a first layer that is a layer in a neural network, and a channel in a 0th layer which is a previous layer to the first layer,
executing a determination process for dividing channels in the 0th layer and channels in the first layer into groups whose number is equal to the number of chips that are included in an operation device executing an operation of the neural network using a learning result of the weight for each edge, respectively, determining association of the groups of the channels in the 0th layer and the groups of the channels in the first layer and the chips included in the operation device, and edges to be removed, and removing the edges to be removed, and
executing a weight assignment process for storing the weights for the edges each connecting the channel in the 0th layer and the channel in the first layer to a weight storage unit in the chip corresponding to the edge.

(Supplementary note 7) The assignment method, implemented by the computer, according to supplementary note 6,
wherein
the computer executes, in the determination process,
   a candidate generation process for generating a plurality of candidates for combination of grouping of the channels in the 0th layer, grouping of the channels in the first layer, the association of the groups of the channels in the 0th layer and the groups of the channels in the first layer and the chips, and edges to be removed,
   a simulation execution process for executing a simulation of the operation of the neural network in the operation device for each of the candidates for combination and deriving an index that represents both accuracy and speed of the operation, and
   a combination determination process for determining the combination corresponding to the candidate with the highest index as the combination of the grouping of the channels in the 0th layer, the grouping of the channels in the first layer, the association of the groups of the channels in the 0th layer and the groups of the channels in the first layer and the chips, and edges to be removed, and removing edges to be removed included in determined combination, and
in the weight assignment process, the computer stores the weight for the edge connecting the channel in the 0th layer and the channel in the first layer to a weight storage unit in the chip corresponding to the edge, based on the combination determined by the combination determining process.

(Supplementary note 8) The assignment method, implemented by the computer, according to supplementary note 6,
wherein
in the learning process, the computer learns the weights of each edge so that the weights of a predetermined percentage of the number of edges connecting the channels in the first layer to the channels in the 0th layer are as 0 or close to 0 as possible, and
in the determination process, the computer
   removes the edges whose weights learned by the learning process are equal to or less than a threshold value, divides the channels in the 0th layer and the channels in the first layer into the groups whose number is equal to the number of chips that are included in the operation device so that a condition that the channels, connected by the removed edges, in the 0th layer and in the first layer, wherein the channels belong to non-corresponding groups of channels in the 0th layer and in the first layer respectively, is satisfied, and determines the association of the groups of the channels in the 0th layer and the groups of the channels in the first layer and the chips included in the operation device.

((Supplementary note 9) An assignment program causing a computer to execute:
a learning process for learning a weight for each edge connecting a channel in a first layer that is a layer in a neural network, and a channel in a 0th layer which is a previous layer to the first layer,
a determination process for dividing channels in the 0th layer and channels in the first layer into groups whose number is equal to the number of chips that are included in an operation device executing an operation of the neural network using a learning result of the weight for each edge, respectively, determining association of the groups of the channels in the 0th layer and the groups of the channels in the first layer and the chips included in the operation device, and edges to be removed, and removing the edges to be removed, and
a weight assignment process for storing the weights for the edges each connecting the channel in the 0th layer and the channel in the first layer to a weight storage unit in the chip corresponding to the edge.

(Supplementary note 10) The assignment program according to supplementary note 9, causing the computer to execute
in the determination process,
   a candidate generation process for generating a plurality of candidates for combination of grouping of the channels in the 0th layer, grouping of the channels in the first layer, the association of the groups of the channels in the 0th layer and the groups of the channels in the first layer and the chips, and edges to be removed,
   a simulation execution process for executing a simulation of the operation of the neural network in the operation device for each of the candidates for combination and deriving an index that represents both accuracy and speed of the operation, and
   a combination determination process for determining the combination corresponding to the candidate with the highest index as the combination of the grouping of the channels in the 0th layer, the grouping of the channels in the first layer, the association of the groups of the channels in the 0th layer and the groups of the channels in the first layer and the chips, and edges to be removed, and removing edges to be removed included in determined combination,
wherein in the weight assignment process, the program causes the computer to store the weight for the edge connecting the channel in the 0th layer and the channel in the first layer to a weight storage unit in the chip corresponding to the edge, based on the combination determined by the combination determining process.

(Supplementary note 11) The assignment program according to supplementary note 9,
wherein
in the learning process, the program causes the computer to learn the weights of each edge so that the weights of a predetermined percentage of the number of edges connecting the channels in the first layer to the channels in the 0th layer are as 0 or close to 0 as possible, and
in the determination process, the program causes the computer to
   remove the edges whose weights learned by the learning process are equal to or less than a threshold value, divide the channels in the 0th layer and the channels in the first layer into the groups whose number is equal to the number of chips that are included in the operation device so that a condition that the channels, connected by the removed edges, in the 0th layer and in the first layer, wherein the channels belong to non-corresponding groups of channels in the 0th layer and in the first layer respectively, is satisfied, and determine the association of the groups of the channels in the 0th layer and the groups of the channels in the first layer and the chips included in the operation device.

While the present invention has been described with reference to the example embodiments, the present invention is not limited to the aforementioned example embodiments. Various changes understandable to those skilled in the art within the scope of the present invention can be made to the structures and details of the present invention.

### INDUSTRIAL APPLICABILITY

The present invention is suitably applied to an assignment device that assigns weights in a neural network to chips of an operation device that executes operations of a neural network by a plurality of chips.

### REFERENCE SIGNS LIST

1 Operation device
10, 20 Chip
11, 21 Weight storage unit
12, 22 Operation circuit
13, 23 Communication circuit
30, 40 Assignment device
31, 41 Learning unit
32, 42 Determination unit
33, 43 Weight assignment unit
34 Candidate generation unit
35 Simulation execution unit
36 Combination determination unit
37 Test data storage unit

What is claimed is:

1. An assignment device comprising:
a learning unit which learns a weight for each edge connecting a channel in a first layer that is a layer in a neural network, and a channel in a 0th layer which is a previous layer to the first layer,
a determination unit which divides channels in the 0th layer and channels in the first layer into groups whose number is equal to the number of chips that are included in an operation device executing an operation of the neural network using a learning result of the weight for each edge, respectively, determines association of the groups of the channels in the 0th layer and the groups of the channels in the first layer and the chips included in the operation device, and edges to be removed, and removes the edges to be removed, and
a weight assignment unit which stores the weights for the edges each connecting the channel in the 0th layer and the channel in the first layer to a weight storage unit in the chip corresponding to the edge.

2. The assignment device according to claim 1,
wherein
the determination unit includes:
a candidate generation unit which generates a plurality of candidates for combination of grouping of the channels in the 0th layer, grouping of the channels in the first layer, the association of the groups of the channels in the 0th layer and the groups of the channels in the first layer and the chips, and edges to be removed,
a simulation execution unit which executes a simulation of the operation of the neural network in the operation device for each of the candidates for combination and derives an index that represents both accuracy and speed of the operation, and
a combination determination unit which determines the combination corresponding to the candidate with the highest index as the combination of the grouping of the channels in the 0th layer, the grouping of the channels in the first layer, the association of the groups of the channels in the 0th layer and the groups of the channels in the first layer and the chips, and edges to be removed, and removes edges to be removed included in determined combination, and
the weight assignment unit stores the weight for the edge connecting the channel in the 0th layer and the channel in the first layer to a weight storage unit in the chip corresponding to the edge, based on the combination determined by the combination determining unit.

3. The assignment device according to claim 2, wherein
the candidate generation unit identifies predetermined number of edges in the order that the weights are close to 0, and generates a plurality of candidates for combination of the grouping of the channels in the 0th layer, the grouping of the channels in the first layer, the association of the groups of the channels in the 0th layer and the groups of the channels in the first layer and the chips, and edges to be removed, under the condition that the identified predetermined number of edges are defined as the edges to be removed.

4. The assignment device according to claim 2, wherein
the candidate generation unit identifies an edge whose weight is closest to 0, and generates a plurality of candidates for combination of the grouping of the channels in the 0th layer, the grouping of the channels in the first layer, the association of the groups of the channels in the 0th layer and the groups of the channels in the first layer and the chips, and edges to be removed, under the condition that the identified edge is defined as the edge to be removed.

5. The assignment device according to claim 1,
wherein
the learning unit learns the weights of each edge so that the weights of a predetermined percentage of the number of edges connecting the channels in the first layer to the channels in the 0th layer are as 0 or close to 0 as possible, and
the determination unit removes the edges whose weights learned by the learning unit are equal to or less than a threshold value, divides the channels in the 0th layer and the channels in the first layer into the groups whose number is equal to the number of chips that are included in the operation device so that a condition that the channels, connected by the removed edges, in the 0th layer and in the first layer, wherein the channels belong to non-corresponding groups of channels in the 0th layer and in the first layer respectively, is satisfied, and determines the association of the groups of the channels in the 0th layer and the groups of the channels in the first layer and the chips included in the operation device.

6. An assignment method, executed by a computer, comprising:
executing a learning process for learning a weight for each edge connecting a channel in a first layer that is a layer in a neural network, and a channel in a 0th layer which is a previous layer to the first layer,
executing a determination process for dividing channels in the 0th layer and channels in the first layer into groups whose number is equal to the number of chips that are included in an operation device executing an operation of the neural network using a learning result of the weight for each edge, respectively, determining association of the groups of the channels in the 0th layer and the groups of the channels in the first layer and the chips included in the operation device, and edges to be removed, and removing the edges to be removed, and
executing a weight assignment process for storing the weights for the edges each connecting the channel in the 0th layer and the channel in the first layer to a weight storage unit in the chip corresponding to the edge.

7. The assignment method, implemented by the computer, according to claim 6,
wherein
the computer executes, in the determination process,
a candidate generation process for generating a plurality of candidates for combination of grouping of the channels in the 0th layer, grouping of the channels in the first layer, the association of the groups of the channels in the 0th layer and the groups of the channels in the first layer and the chips, and edges to be removed,
a simulation execution process for executing a simulation of the operation of the neural network in the operation device for each of the candidates for combination and deriving an index that represents both accuracy and speed of the operation, and
a combination determination process for determining the combination corresponding to the candidate with the highest index as the combination of the grouping of the channels in the 0th layer, the grouping of the channels in the first layer, the association of the groups of the channels in the 0th layer and the groups of the channels in the first layer and the chips, and edges to be removed, and removing edges to be removed included in determined combination, and
in the weight assignment process, the computer stores the weight for the edge connecting the channel in the 0th layer and the channel in the first layer to a weight storage unit in the chip corresponding to the edge, based on the combination determined by the combination determining process.

8. The assignment method, implemented by the computer, according to claim 6,
wherein
in the learning process, the computer learns the weights of each edge so that the weights of a predetermined percentage of the number of edges connecting the channels in the first layer to the channels in the 0th layer are as 0 or close to 0 as possible, and
in the determination process, the computer
removes the edges whose weights learned by the learning process are equal to or less than a threshold value, divides the channels in the 0th layer and the channels in the first layer into the groups whose number is equal to the number of chips that are included in the operation device so that a condition that the channels, connected by the removed edges, in the 0th layer and in the first layer, wherein the channels belong to non-corresponding groups of channels in the 0th layer and in the first layer respectively, is satisfied, and determines the association of the groups of the channels in the 0th layer and the groups of the channels in the first layer and the chips included in the operation device.

9. A non-transitory computer-readable recording medium in which an assignment program is recorded, the assignment program causing a computer to execute:
a learning process for learning a weight for each edge connecting a channel in a first layer that is a layer in a neural network, and a channel in a 0th layer which is a previous layer to the first layer,
a determination process for dividing channels in the 0th layer and channels in the first layer into groups whose number is equal to the number of chips that are included in an operation device executing an operation of the neural network using a learning result of the weight for each edge, respectively, determining association of the groups of the channels in the 0th layer and the groups of the channels in the first layer and the chips included in the operation device, and edges to be removed, and removing the edges to be removed, and
a weight assignment process for storing the weights for the edges each connecting the channel in the 0th layer and the channel in the first layer to a weight storage unit in the chip corresponding to the edge.

10. The non-transitory computer-readable recording medium according to claim 9, wherein the assignment program causes the computer to execute
in the determination process,
a candidate generation process for generating a plurality of candidates for combination of grouping of the channels in the 0th layer, grouping of the channels in the first layer, the association of the groups of the channels in the 0th layer and the groups of the channels in the first layer and the chips, and edges to be removed,
a simulation execution process for executing a simulation of the operation of the neural network in the operation device for each of the candidates for combination and deriving an index that represents both accuracy and speed of the operation, and
a combination determination process for determining the combination corresponding to the candidate with the highest index as the combination of the grouping of the channels in the 0th layer, the grouping of the channels in the first layer, the association of the groups of the channels in the 0th layer and the groups of the channels in the first layer and the chips, and edges to be removed, and removing edges to be removed included in determined combination,
wherein in the weight assignment process, the program causes the computer to store the weight for the edge connecting the channel in the 0th layer and the channel in the first layer to a weight storage unit in the chip corresponding to the edge, based on the combination determined by the combination determining process.

11. The non-transitory computer-readable recording medium according to claim 9,
wherein
in the learning process, the program causes the computer to learn the weights of each edge so that the weights of a predetermined percentage of the number of edges connecting the channels in the first layer to the channels in the 0th layer are as 0 or close to 0 as possible, and
in the determination process, the program causes the computer to
remove the edges whose weights learned by the learning process are equal to or less than a threshold value, divide the channels in the 0th layer and the channels in the first layer into the groups whose number is equal to the number of chips that are included in the operation device so that a condition that the channels, connected by the removed edges, in the 0th layer and in the first layer, wherein the channels belong to non-corresponding groups of channels in the 0th layer and in the first layer respectively, is satisfied, and determine the association of the groups of the channels in the 0th layer and the groups of the channels in the first layer and the chips included in the operation device.
